(19) United States
(12) Patent Application Publication
(10) Pub. No.: US 2009/0187475 A1
(43) Pub. Date: Jul. 23, 2009

(54) Computer System and Method for Matching Businesses and Investors

(76) Inventors: Rick Austin, Orlando, FL (US); Gary Neumann, Orlando, FL (US)

Correspondence Address: Michael L. Leetzow, Esq.;Michael L. Leetzow, P.A., 5213 SHORELINE CIRCLE, SANFORD, FL, 32771, US

(21) Appl. No.: 12/355,460

(22) Filed: Jan. 16, 2009

Related U.S. Application Data
(60) Provisional application No. 61/021,942, filed on Jan. 18, 2008.

(51) Int. Cl. G06Q 99/00

(52) U.S. Cl. 705/12; 705/1

(57) ABSTRACT

A computer system allows businesses and investors to present information about themselves and allow the two find one another for working together. The businesses may also present their business on a television program, where judges and the audience will be able to vote for the best business. The businesses participate on the television program by receiving votes on the website hosted by the computer system.

### REFERENCE TO RELATED CASE

This application claims priority under 35 U.S.C. §119 (e) to provisional application No. 61/021,942, filed on Jan. 18, 2008, which is hereby incorporated by reference in its entirety.

### BACKGROUND OF THE INVENTION

1. Field of the Invention

The present invention relates generally to a computer system and method for matching investors and businesses with one another and, in particular, a computer system and method for matching investors looking to assist businesses looking for assistance with those businesses and also a method for discovering the best businesses through presentations, particularly on television.

2. Technical Background

There are multiple websites that allow businesses to display their business plans in hopes of attracting assistance from more knowledgable business people. The assistance requested by these businesses may range from monetary investments to providing advice to providing services (i.e., advertising, public relations, etc.). There are also websites where investors can identify themselves as being available to assist businesses. Some of the websites even provide a way to search for one another on the website, but they do not provide a place where investors and businesses can interact with one another, exchange more than general information, and make themselves available to be contacted.

Very few business plans get funded, with even fewer receiving funding from venture capitalists or private investors, mostly because it is difficult for these two sides to get access to one another.

It would be desirable therefore to provide a venue for businesses and investors (and service providers) where they can all exchange information about themselves/businesses and allow for them to interact with one another, both directly and on the system. To bring more visibility to the businesses and investors, the businesses have an opportunity, based on feedback from others on the website, to participate in a “game show” television program where the businesses present their business plans and the audience (both in the studio and in the television audience) will be able to vote on the best business plans. The winners of each program win valuable prizes and a chance to compete against other winners for an overall winner.

### SUMMARY OF THE INVENTION

Disclosed herein is a method of matching investors with businesses that includes the steps of storing on a storage medium information about the businesses, the stored information including a video about the business, storing on the storage medium information about the investors, the information about the investors including a video about the investor, providing a search engine for the business and the investors to search the information of one another stored on the storage medium. and providing a list of entities that match criteria entered into the search engine.

In some embodiments, the businesses and investors can vote for a particular business.

In another embodiment, the method also includes the steps of identifying those businesses having a predetermined number of votes, allowing those identified businesses to make a presentation to an audience, recording votes by the audience for the identified businesses and awarding prizes to the businesses based on the votes by the audience

In another aspect, a computer system for matching investors with businesses is disclosed, the computer system configured to store on a storage medium information about the businesses, the stored information including a video about the business, store on the storage medium information about the investors seeking businesses, the information about the investors including a video about the investor, allow businesses and the investors to search for one another based on criteria that is included in the information stored on the storage medium; and provide a list of entities that match the searched criteria.

In yet another aspect, a method of identifying a business to be awarded prizes from a plurality of businesses is disclosed, the method comprising the steps of storing information about each of the businesses on a storage medium, allowing the information to be viewed by others, at least some of the viewing being done remotely, allowing others to vote for at least one of the plurality of businesses, totaling the votes received by each of the businesses, selecting a first predetermined number of the businesses to make a presentation before an audience based on the total number of votes received by each of the businesses, allowing the audience to vote for a second predetermined number of the businesses making a presentation, and awarding prizes to the business receiving the most votes from the audience.

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

It is to be understood that both the foregoing general description and the following detailed description of the present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principles and operations of the invention.

### BRIEF DESCRIPTION OF THE DRAWINGS

FIG. 1 is a block diagram of a computer system according to a first embodiment of the present invention;

FIG. 2 is a diagram of a server according to one embodiment of the present invention;

FIG. 3 is a flow chart illustrating the operation of the website for members;

FIG. 4 is a flow chart illustrating the operation of the television program available to the members of the website; and

FIG. 5 is a flow chart illustrating the operation of the website for the non-members.

### DETAILED DESCRIPTION OF THE PREFERRED EMBODIMENTS

Reference will now be made in detail to the present preferred embodiment(s) of the invention, examples of which are illustrated in the accompanying drawings. Whenever possible, the same reference numerals will be used throughout the drawings to refer to the same or like parts.

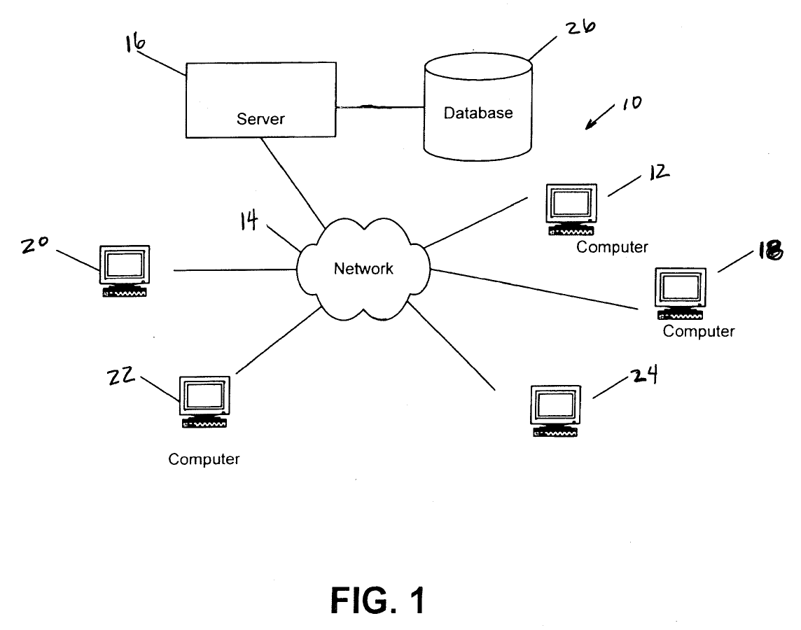

Referring to FIG. 1, a computer system 10 according to one embodiment of the present invention is illustrated. The computer system 10 includes at least computer 12 that is connected (e.g., via a network 14 such as a LAN or a global communications network, such as the Internet) to communicate with a system server 16. The computer system 10 may also include other computers that are connected (e.g., via a network 14 such as a LAN or a global communications network, such as the Internet) to communicate with the system server 16. Such computers may include a computer 18 of the business (e.g., one or more computers of businesses that are members as described in detail below), an investor computer 20 (e.g., one or more computers of investors that are members as described in detail below), public computer 22 (e.g., computers that are used by people who are not members but would like to view information. The system administrator may also be able to gain access through computer 24, although access is available directly through the system server 16.

In one embodiment of the invention, the system server 16 is configured for retrieving data from, and for saving data to, a database 26 that may be stored on (or, alternatively, stored remotely from) the system server 16. In the embodiment shown in FIG. 1, the database 26 is preferably maintained on a computer that is remote from the system server 16.

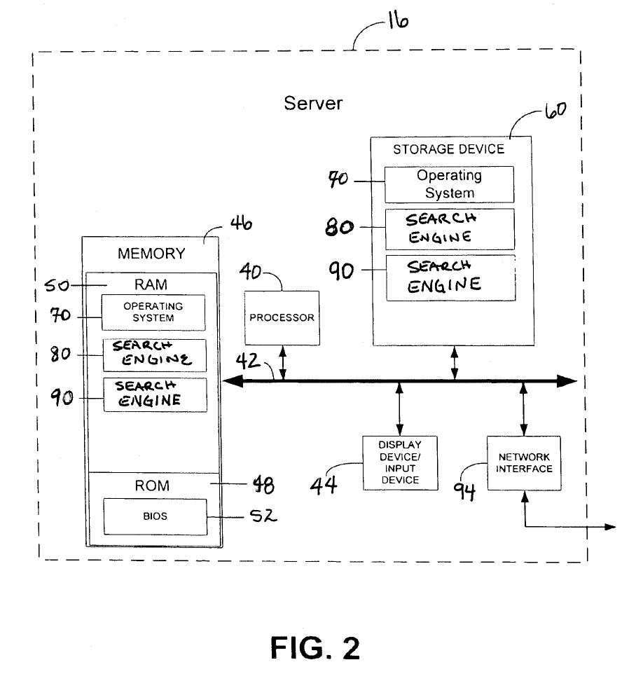

FIG. 2 shows a schematic diagram of the system server 16 according to one embodiment of the invention. As may be understood from this figure, in this embodiment, the system server 16 includes a processor 40 that communicates with other elements within the system server 16 via a system interface or bus 42. Also included in the system server 16 is a display device/input device 44 for receiving and displaying data. This display device/input device 44 may be, for example, a keyboard or pointing device that is used in combination with a monitor. The system server 16 further includes memory 46, which preferably includes both read only memory (ROM) 48 and random access memory (RAM) 50. The server's ROM 48 is used to store a basic input/output system 52 (BIOS), containing the basic routines that help to transfer information between elements within the system server 16.

In addition, the system server 16 includes at least one storage device 60, such as a hard disk drive, a floppy disk drive, a CD ROM drive, or optical disk drive, for storing information on various computer-readable media, such as a hard disk, a removable magnetic disk, or a CD-ROM disk. As will be appreciated by one of ordinary skill in the art, each of these storage devices 60 is connected to the system bus 42 by an appropriate interface. The storage devices 60 and their associated computer-readable media provide nonvolatile storage for a personal computer. It is important to note that the computer-readable media described above could be replaced by any other type of computer-readable media known in the art. Such media include, for example, magnetic cassettes, flash memory cards, digital video disks, and Bernoulli cartridges.

A number of program modules may be stored by the various storage devices and within RAM 50. Such program modules include an operating system 70, a search engine 80 and a second more limited search engine 90 as described below. The search engines 80 and 90 control certain aspects of the operation of the system server 18, with the assistance of the processor 40 and an operating system 70.

Also located within the system server 16 is a network interface 94, for interfacing and communicating with other elements of a computer network. It will be appreciated by one of ordinary skill in the art that one or more of the system server 16 components may be located geographically remotely from other system server 16 components. Furthermore, one or more of the components may be combined, and additional components performing functions described herein may be included in the system server 16.

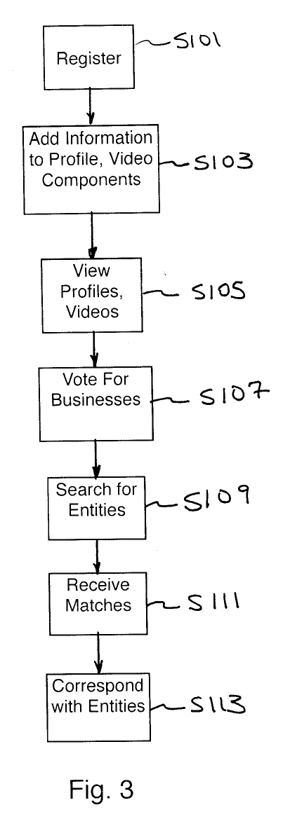

FIG. 3 illustrates the steps for the website that could be stored and administered from the system server 16. A business that is interested in receiving assistance in its business can register at step S101. There are many ways in which the registration can occur, including directly through the computer system 10, or by filling out appropriate paperwork that can be mailed, faxed, or emailed to be registered on the system. The business may be required to pay a fee, either as a one-time fee or on a continuing basis, depending on the amount of time the business would like to be a member. Similarly, an investor that is looking to provide assistance to the businesses that have registered (or may register in the future) may also register at step S101. The registration process may be the same (except for designation of type of registrant) or may be different and still fall within the scope of the present invention. As used herein, “investor” may mean any type of business, entity, or person that has some expertise, input or other information that may be assistance to businesses. This would include angel investors, venture capitalists, foundations, retired executives, services providers (public relations, advertising, media experts, etc.) or anyone else who would like to provide help and assistance (but not only monetarily). Similarly, “assistance” does not simply mean monetary assistance, but could be of any form or format that would be beneficial to the businesses. Some examples would include CEO or CFO services, marketing and legal advice, monetary funding, design assistance, engineering, etc.

Once the business or investor (may be referred to an “entity” hereinafter for convenience) has registered, the entity may provide information on the business or services that it provides at step S103. Preferably the information is entered into a standard format form so that it is, as noted below, searchable, any format can be used and fall within the scope of the present invention. It is also possible that there be pre-formatted information forms as well as free-form information entry. The entities will also be able to upload onto the database a video presentation of the business/service that the entity provides to assist others in understanding the business/service. Preferably, the video presentations will be limited in time, for example, less than 3 minutes, but any reasonable length of video will be accepted. The information added by the entities can be updated and revised as needed, as long as the entity is a member. Once the membership lapses, the information will be automatically purged.

As step S105, the members, i.e., those who have registered and paid any associated fee, will be allowed to view all of the other profiles of other members (both businesses and investors). While viewing the profiles (as well as the video component), the members will be allowed to vote at step S107 for those businesses that they believe are worthy of being on the television show, described in more detail below. The votes will also be indicative of the type of venture or business that is presented. Those members who are merely there to scam or take advantage of the businesses will be quickly discovered and eliminated from the membership.

As noted above, the members or registered entities will be able to search all of the other members based on certain criteria, as illustrated as step S109. This will be done with, for example, the search engine 80. Investors will be able to seek out businesses that meet a certain criteria (industry, size, skills needed, etc.). Similarly, businesses will be able to search for particular types of investors for providing particular assistance that they need. They will receive at step S111 a list of entities that match the entered search criteria.

Also as a part of the system, the members/entities will be able to contact one another, either directly using contact information provided during registration or information entry and/or in an on-line forum, such as a blog or message system. Again, after corresponding and working with one another, the entities have the opportunity to go back and provide feedback related to the services and/or business to keep the integrity and the purpose of the site at the highest levels.

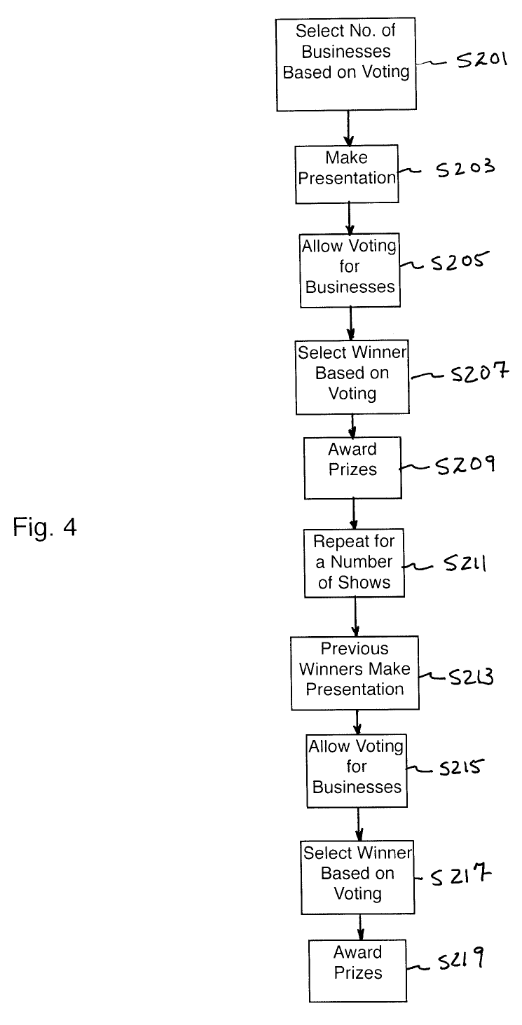

FIG. 4 illustrates how the information and entities that have registered on the computer system 10 can be used to dovetail into an entertaining and promotion program. At step S201, a predetermined number of businesses are selected to make a presentation for an audience. Preferably, the businesses that are selected have a high number of votes by other members (businesses and investors). It is also possible for the program directors to choose the businesses that will make the presentations while using the votes as a guide.

At step S203, the businesses make a presentation about their business and why it should win the prizes that are to be awarded or assisted by an investor. While it is preferable that the presentations are made to be broadcast as a television program, it is also possible that the presentations are recorded for web viewing or viewed in any other appropriate medium (e.g., DVD). The presentations will be preferably made in front of an audience, including at least some in the recording studio. The presentations will also be preferably be viewed by a panel of experts, who will guide, critique and advise the businesses about the presentation and the business itself. The number of presentations will be limited in time so that a number of presentations can be made during the program. The number of presentations during any one program will preferably be between 5 and 15, depending on the length of the program, the type of businesses, etc.

At the end of the program, the audience and/or the panel will be able to vote for the business presentation during that program at step S205. Votes may also come from the other member businesses or even from the audience that is viewing the program by television, on the internet, or both. The winning business will then be announced at an appropriate time at step S207, and prizes will be awarded to the winner at step S209. The prizes may include monetary prizes to assist with the business plans, or supplies and/or services to assist the business. For example, the business may be awarded assistance in designing a website or a marketing campaign, or receive free wireless service for a year.

The process can then be repeated a number of times as indicated at step S211. That is, businesses will be selected, they will make a presentation on a program, votes are tabulated and winners are announced and awarded prizes.

At step S213, the previous winners (from the multiple programs at S207) will make a presentation (which may be updated or the same as the prior presentation) in a new program that will may also be broadcast on television, via the internet or any other appropriate medium. Preferably, these presentations will also be made in front of an audience and a panel of experts as in the previous rounds of presentations. Also, voting for the businesses is then opened or allowed at step S215. Again, the voting can be done by the audience (present and remote), the panel of experts, and the other businesses and investors. A winner is selected based on the voting at step S217 and prizes are awarded to the winner at step S219. The prizes will be similar to those offered to the prior winners, but will generally be greater in value and/or scope.

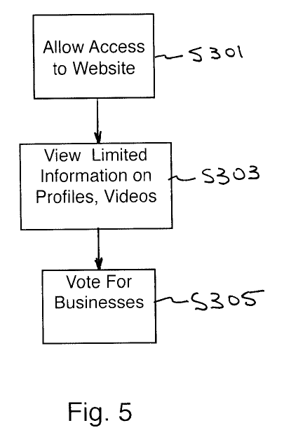

Having the presentations made on a program will raise the awareness of the website/computer system and allow for more investors and businesses to potentially join, bringing greater resources to those that are members and have information stored. It is also desired to allow the general public to have at least limited access to some of the information of the businesses and investors. However, it is also recognized that some of the businesses and investors may not want to make their information available to the public (and indeed many of the investors may not want any of their information made available). Therefore, each of the entities will be able to decide how much information is available to be searched and viewed by the general public. For those businesses that are selected to make presentations, those presentations will be made available to any one visiting the website. There is also, as noted in FIG. 5, a way for the general public (those who have not registered and loaded information) to search some of the stored information. As step S301, the general public is allowed limited access to the website. At step S303, the general public is allowed to view limited information that is available for each of the businesses. It is also anticipated that there will also be general information relevant to businesses and investors that all businesses and investors would be interested in. For example, there may be information and/or articles and/or videos about legal issues facing businesses; human resources information; marketing and promotion information and ideas; how to make effective presentations; what a good business plan contains; advice from experts in a variety of areas; etc. Naturally, these would also be available to the registered entities.

At step S305, the general public will be allowed to vote for the businesses, both before the presentations are done to determine which are selected for presenting on the program as well as after the presentations have been presented to determine which businesses win the prizes on the programs.

It will be apparent to those skilled in the art that various modifications and variations can be made to the present invention without departing from the spirit and scope of the invention. Thus it is intended that the present invention cover the modifications and variations of this invention provided they come within the scope of the appended claims and their equivalents.

What is claimed is:

1. A method of matching investors with businesses, the method comprising the steps of:
storing on a storage medium information about the businesses, the stored information including a video about the business;
storing on the storage medium information about the investors, the information about the investors including a video about the investor;
providing a search engine for the business and the investors to search the information of one another stored on the storage medium; and
providing a list of entities that match criteria entered into the search engine.

2. The method according to claim 1, further comprising:
allowing businesses and investors to vote for a particular business based on a predetermined criteria.

3. The method according to claim 2, further comprising the step of:
identifying those businesses having a predetermined number of votes;
allowing those identified businesses to make a presentation to an audience;
recording votes by the audience for the identified businesses;
awarding prizes to the businesses based on the votes by the audience.

4. The method according to claim 3, wherein the presentation to an audience includes presenting in a television program.

5. The method according to claim 3, wherein the audience also includes a panel of judges.

6. The method according to claim 1, wherein the search engine is available only to the businesses and investors who have information stored on the storage medium.

7. The method according to claim 1, further comprising the step of:
providing a search engine for others who do not have information stored on the storage medium, wherein only some of the information stored on the storage medium is available to be searched by the others.

10. A computer system for matching investors with businesses, the computer system configured to:
store on a storage medium information about the businesses, the stored information including a video about the business;
store on the storage medium information about the investors seeking businesses, the information about the investors including a video about the investor;
allow businesses and the investors to search for one another based on criteria that is included in the information stored on the storage medium; and
provide a list of entities that match the searched criteria.

11. The computer system according to claim 10, the computer system further configured to:
allow businesses and investors to vote for a particular business based on a predetermined criteria.

12. The computer system according to claim 10, wherein the computer system is further configured to allow only businesses and investors who have information stored on the storage medium to search the information of businesses and investors stored on the storage medium.

13. The computer system according to claim 10, wherein the computer system is further configured to allow others to search the information stored on the storage medium, wherein only some of the information stored on the storage medium is available to be searched by the others.

14. A method of identifying a business to be awarded prizes from a plurality of businesses, the method comprising the steps of:
a. storing information about each of the businesses on a storage medium;
b. allowing the information to be viewed by others, at least some of the viewing being done remotely;
c. allowing others to vote for at least one of the plurality of businesses;
d. totaling the votes received by each of the businesses;
e. selecting a first predetermined number of the businesses to make a presentation before an audience based on the total number of votes received by each of the businesses;
f. allowing the audience to vote for a second predetermined number of the businesses making a presentation; and
g. awarding prizes to the business receiving the most votes from the audience.

15. The method according to claim 14, wherein the information stored on the storage medium includes a video component.

16. The method according to claim 14, wherein the first predetermined number is between 5 and 15.

17. The method according to claim 14, further comprising the steps of:
storing information about investors interested in assisting the businesses; and
allowing the investors to vote for at least one of the plurality of businesses.

18. The method according to claim 14, further comprising the steps of:
repeating steps c-f a plurality of times;
allowing each of the businesses that received the most votes from the audience voting to make another presentation to an audience;
allowing the audience to votes for at least one of the businesses making presentations;
awarding prizes to the business that receives the most votes from the audience.

19. The method according to claim 18, wherein the presentations are done on a television program.

20. The method according to claim 18, wherein at least part of the audience votes from remote locations.
